(19) United States
(12) Patent Application Publication
(10) Pub. No.: US 2008/0062850 A1
(43) Pub. Date: Mar. 13, 2008

(54) Optical pickup and optical disc apparatus

(75) Inventor: Kenichi Shimada, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: HitachiMedia Electronics Co., Ltd., Oshu (JP)

(21) Appl. No.: 11/698,482

(22) Filed: Jan. 25, 2007

(30) Foreign Application Priority Data
Sep. 8, 2006 (JP) 2006-243540

(51) Int. Cl. G11B 7/135

(52) U.S. Cl. 369/112.04

(57) ABSTRACT

In an optical pickup compatible with BD and HD DVD, when DPP method is used as a tracking error signal detection system for both BD and HD DVD, since the guide groove pitch of the optical disc differs between BD and HD DVD, when a diffraction grating for generation of three beams is shared by both, it is difficult to adjust a spot distance on recording layer of optical disc to ½ of the guide groove pitch for both. Assuming that lateral magnification of the BD optical system is M₁, lateral magnification of the HD DVD optical system is M₂, a spot distance of three beams on BD-R/RE is S₁, a spot distance of three beams on HD DVD-R/RW is S₂ the guide groove pitch of BD-R/RE is T₁ and the guide groove pitch of HD DVD-R/RW is T₂, a setting is made to meet Formulas 1 and 2.

The present application claims priority from Japanese application JP2006-243540 filed on Sep. 8, 2006, the content of which is hereby incorporated by reference into this application.

### BACKGROUND OF THE INVENTION

(1) Field of the Invention

The present invention relates to an optical pickup and an optical disc apparatus.

(2) Description of Related Art

An example of related arts of the present invention is JP-A-2006-172605 (hereinafter, referred to as “Patent Document 1”). This publication discloses that “a phase switching element which can change phases of incident beam and a hologram element which lets the incident beam pass, diverge or converge according to the phase selected by the phase switching element are disposed on the light-emitting element side of an objective lens.”

Another example of related arts of the present invention is JP-A-2006-147075 (hereinafter referred to as “Patent Document 2”). This publication describes that “when the above described optical disc has the first thickness of cover layer, the above described first light source and the above described first objective lens are used and when the above described optical disc has the second thickness of cover layer, the above described first light source and the above described second objective lens are used” and “characterised by the combination between the above described light source and the objective lens.”

### BRIEF SUMMARY OF THE INVENTION

In order to support reproduction and recording of digital information which is growing in scale and volume year after year, there are proposals of a BD (Blu-ray Disc) standard using a violet laser having a wavelength of 405 nm, a high NA objective lens having a numerical aperture of 0.85 and a disc medium having a cover layer thickness of 0.1 mm and an HD DVD (High Definition Digital Versatile Disc) standard also using a violet laser having a wavelength of 405 nm, NA 0.65, and a disc medium having a cover layer thickness of 0.6 mm or the like as next-generation high density optical discs.

Several manufacturers have already started shipment of products adopting the BD standard and HD DVD standard such as AV recorder or player and PC optical disc drive and these products are expected to replace current DVD products and become increasingly widespread on the market in the future.

When both optical disc apparatuses adopting the BD standard and HD DVD standard are widespread, it is predicted that there will be a growing demand for an optical disc apparatus capable of supporting both BD and HD DVD on the market, but at present no such optical disc apparatus supporting both the BD and the HD DVD standards with a single apparatus has been produced. Products which have been produced so far are optical disc apparatuses supporting three types of optical discs of BD, DVD and CD and optical disc apparatuses supporting three types of optical discs of HD DVD, DVD and CD, and though there are optical disc apparatuses compatible with current DVD and CD, no optical disc apparatus compatible with both BD and HD DVD has ever been produced.

When thinking of an optical pickup compatible with BD and HD DVD, though both standards use the same wavelength, they are considerably different in the thickness of cover glass and objective lens NA, which causes an important problem. Especially, the thickness of the cover glass of BD is 0.1 mm which is substantially different from 0.6 mm of HD DVD and this causes a problem that a considerable spherical aberration corresponding to this difference occurs.

Against such a background, techniques related to an optical pickup supporting both BD and HD DVD can be roughly divided into the following two systems. The first is a system that supports BD and HD DVD using the same objective lens and the second is a system that uses two objective lenses; objective lens for BD and objective lens for HD DVD.

For example, as described in Patent Document 1 (paragraph on page 3), the first system realizes a correction of a spherical aberration and a desired objective lens NA by “disposing a phase switching element which can change phases of parallel light flux and a hologram element which lets the incident beam pass, diverge or converge according to the phase selected by the phase switching element on the light-emitting element side of an objective lens.”

Here, because the diameter of a light spot focused on an optical disc is proportional to the wavelength, the diameter of a light spot when recording/reproducing BD or HD DVD is by far smaller than that of DVD and CD and an energy density of the light spot tends to increase. Therefore, in order to prevent information from being erased when reproducing BD or HD DVD, as for power with which light is outputted from an objective lens, light must be irradiated onto an optical disc with smaller power than that of a conventional DVD or CD. To secure a sufficient SN ratio of a signal in such a situation, a PBS prism is generally used as a beam splitter for the purpose of increasing light utilization efficiency in an optical pickup optical system compatible with BD or HD DVD. In this case, since the polarization direction of a light beam which is outputted from laser toward the optical disc and just before incident on PBS prism and the polarization direction of a light beam which is reflected by the optical disc and just before incident on PBS prism are made to be orthogonal to each other, a combination with a (¼)λ wave plate is necessary. However, since Patent Document 1 adopting the above described first system uses a polarization hologram element right below the objective lens, from the standpoint of the polarization direction, the affinity with the above described (¼)λ wave plate is not good. As a result, unnecessary diffracted light is generated at the hologram element and a reduction of the light utilization efficiency or the like becomes a problem.

On the other hand, as in the case of the above described second system with two objective lenses, that is to say, BD objective lens and HD DVD objective lens are used, since there is good affinity with the configuration using the aforementioned combination of the PBS prism and (¼)λ wave plate, it is advantageous in the aspect of light utilization efficiency. For example, the above described second system is disclosed in Patent Document 2 (paragraph on page 4) as “when the above described information recording medium has a first cover layer, the above described first light source and the above described first objective lens are used and when the above described information recording medium has a second cover layer, the above described first light source and the above described second objective lens are used” and “characterised by the combination of the above described light source and the objective lens can be changed.”

Thus, by adopting the configuration of switching between objective lenses used according to the optical disc for recording or reproduction eliminates the necessity for using the polarization hologram element as shown in Patent Document 1 and the above described second system is more advantageous from the standpoint of light utilization efficiency.

When thinking of an optical pickup compatible with both BD and HD DVD, it is important to take into consideration not only the aforementioned light utilization efficiency but also lower costs. If the aforementioned second system is adopted, other optical parts are preferably shared as much as possible. From such a standpoint, it is important to share not only a semiconductor laser but also a three-beam generation diffraction grating used to generate a light beam for servo signal detection. However, when thinking of sharing the diffraction grating between the two, new problem occurs. This is because there are differences between BD and HD DVD not only in the thickness of the cover layer but also in the pitch of the guide groove of the optical disc as shown in Table 1.

TABLE 1

| BD-R/BD-RE | HD DVD-R/HD DVD-RW |
|---|---|
| 0.32 μm | 0.40 μm |

For example, when a differential push-pull (DPP) method is used as the tracking error signal detection method for both BD and HD DVD, it is necessary to adjust a spot distance in the radius direction of three beams to ½ of the guide groove pitch on the optical disc to stably detect a tracking error signal. However, as shown in Table 1, BD and HD DVD have different guide groove pitches, and therefore it is impossible to adjust both spot distances to ½ of the guide groove pitch with identical diffraction grating. Thus, a mechanism is required as described, for example, in paragraph on page 6 of Patent Document 2, a “diffraction grating mechanism 4 performs rotation of a grating and movement in the direction in which light travels according to the target optical disc 1. A mechanism whereby a liquid crystal element whose grating pitch or angle of grating changes depending on a voltage applied to the diffraction grating may also be used” is required, which makes the mechanism associated with the diffraction grating very complicated.

The present invention has been made in view of the above described problems, and for solving these problems, provides an optical pickup and an optical disc apparatus using this optical pickup according to a system using two objective lenses of a BD objective lens and an HD DVD objective lens, sharing a diffraction grating for light beam generation, the optical pickup can detect a servo signal between the two objective lenses without complicating the mechanism involved in the diffraction grating, adjusting a spot distance in the radius direction of three beams to ½ of the guide groove pitch of each optical disc on the respective optical discs of both BD and HD DVD and capable of thereby detecting a stable tracking error signal using a DPP method.

It is an object of the present invention to provide an optical pickup supporting both BD and HD DVD and an optical disc apparatus comprises such optical pickup.

The above described object can be attained with the configurations described in the claims of the present patent application as an example.

According to the present invention, it is possible to provide an optical pickup supporting both BD and HD DVD and an optical disc apparatus comprises such optical pickup.

### BRIEF DESCRIPTION OF THE SEVERAL VIEWS OF THE DRAWINGS

These and other features, objects and advantages of the present invention will become more apparent from the following description when taken in conjunction with the accompanying drawings wherein:

FIG. 1 illustrates an optical system configuration of an optical pickup according to the present invention;

FIG. 2A illustrates a spot arrangement of three beams on an optical disc;

FIG. 2B illustrates a spot arrangement of three beams on another optical disc;

FIG. 3 is a schematic view showing a relationship between DPP signal amplitude, amount of subspot deviation ΔW on a disc;

FIG. 4 is a schematic view showing lateral magnification of an optical system;

FIG. 5 is a schematic view showing an arrangement of objective lenses 7a and 7b; and

FIG. 6 illustrates an optical disc apparatus according to the present invention.

### DETAILED DESCRIPTION OF PREFERRED EMBODIMENTS

Hereinafter, embodiments for implementing the present invention will be explained.

### Embodiment 1

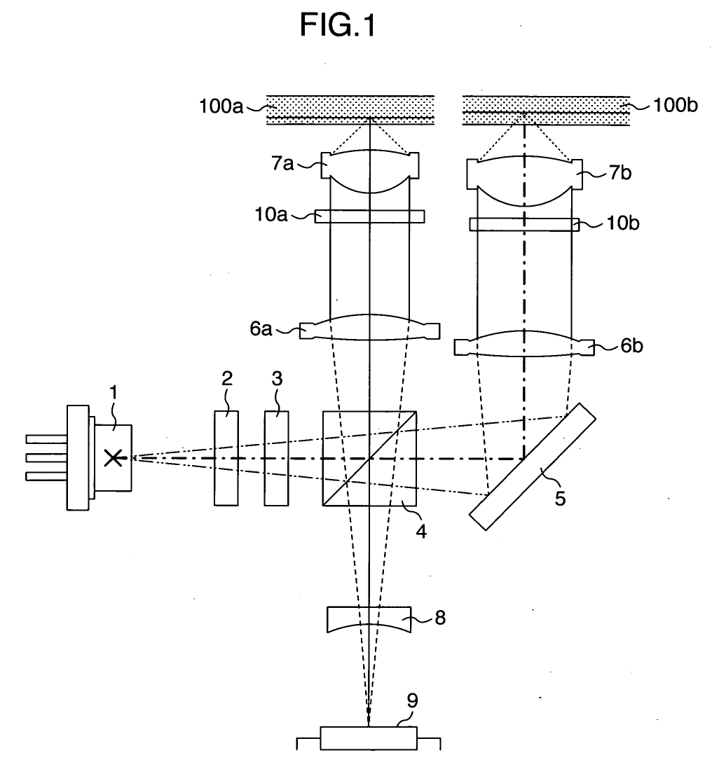

FIG. 1 shows an embodiment of an optical pickup according to the present invention.

The optical pickup of this embodiment is an optical pickup according to a servo signal detection system using three beams and as shown in FIG. 1, generally comprises a semiconductor laser 1 which outputs a light beam having a wavelength λ, a diffraction grating 2 which causes the light beam to diffract and generates a light beam for servo signal detection, an objective lens 7a which condenses a light beam on an optical disc 100a, an objective lens 7b which condenses a light beam on an optical disc 100b and a photodetector 9 which detects a light beam reflected by the optical disc.

The light beam having a wavelength λ outputted from the semiconductor laser 1 is diffracted into at least three light beams by the diffraction grating 2, which enter a polarization direction conversion element 3. The polarization direction conversion element 3 is an element characterized by the ability to control proportions of a P-polarization component and an S-polarization component after being outputted by changing the polarization direction of an incident light beam. Furthermore, a beam splitter 4 has polarization selectivity with respect to transmissivity and reflectivity like a PBS prism, for example. Therefore, when, for example, polarization state of the light beam outputted from the polarization direction conversion element 3 is S-polarization, it is possible to reflect the light beam by the beam splitter 4 and guide it to the optical path of the objective lens 7a, while when polarization state of the light beam outputted from the polarization direction conversion element 3 is P-polarization, it is possible to let pass the light beam through the beam splitter 4 and guide it to the optical path of the objective lens 7b. That is, the optical path can be changed by the control of the polarization direction conversion element 3 and the beam splitter 4.

When performing reproduction or recording of the optical disc 100a, the polarization direction of the light beam after being outputted from the polarization direction conversion element 3 is controlled beforehand using the polarization direction conversion element 3 so that the light beam outputted from the polarization direction conversion element 3 is reflected by the beam splitter 4. The light beam reflected by the beam splitter 4 is collimated by a collimation lens 6a, circularly polarized by a (¼)λ wave plate 10a, enters the objective lens 7a and is condensed on an information recording surface of the optical disc 100a.

The light beam reflected by the optical disc 100a follows a path that is the reverse of the outward path, passes through the beam splitter 4 via the objective lens 7a, (¼)λ wave plate 10a and collimation lens 6a. The light beam which has passed through the beam splitter 4 is given astigmatism by a detection lens 8 in order to be able to detect a focus error signal using astigmatism method and condensed onto the photodetector 9.

Likewise, when performing reproduction or recording of the optical disc 100b, the polarization direction of the light beam after being outputted from the polarization direction conversion element 3 is controlled beforehand using the polarization direction conversion element 3 so that the light beam outputted from the polarization direction conversion element 3 passes through the beam splitter 4. The light beam which has passed through the beam splitter 4 is reflected by a reflection mirror 5 and collimated by a collimation lens 6b, circularly polarized by a (¼)λ wave plate 10b, enters the objective lens 7b and is condensed on an information recording surface of the optical disc 100b.

The light beam reflected by the optical disc 100b follows a path that is the reverse of the outward path and is reflected by the beam splitter 4 after passing through the objective lens 7b, (¼)λ wave plate 10b, collimation lens 6b and reflective mirror 5. The light beam reflected by the beam splitter 4 is given astigmatism so as to be able to detect a focus error signal according to an astigmatism method through the detection lens 8 and is condensed onto the photodetector 9.

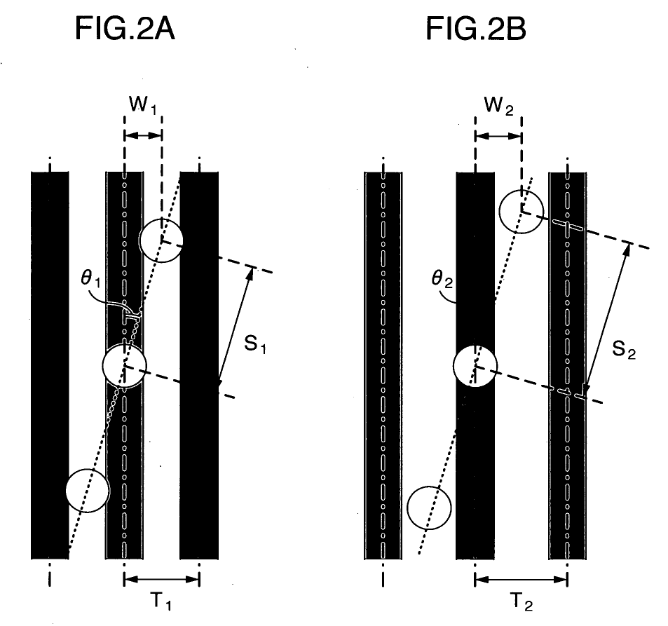

A feature of this embodiment is that the spot distance among three beams formed by the diffraction grating 2 on the optical disc 100a is different from that on the optical disc 100b and that difference depends on the guide groove pitch of the optical disc. This feature will be explained more specifically using FIGS. 2A and 2B.

FIG. 2 is a schematic view showing a spot arrangement of three beams on the optical discs 100a and 100b and a guide groove pitch T₂ shown in FIG. 2B is set to be wider than T₁ shown in FIG. 2A. As shown in above described (Table 1), since the guide groove pitch of HD DVD is wider than that of BD, this is equivalent that FIG. 2A, for example, shows a spot arrangement on BD-R/RE and FIG. 2B shows a spot arrangement on HD DVD-R/RW. The explanations will be continued below on the assumption that, for example, the optical disc 100a shows BD-R/RE and the optical disc 100b shows HD DVD-R/RW.

As shown in FIGS. 2A and 2B, assuming that the inclination of three spots on the optical disc 100a is θ₁ and the inclination of three spots on the optical disc 100b is θ₂, since the diffraction grating 2 is shared in this embodiment, normally θ₁=θ₂=θ.

When a DPP method is applied in such a situation, spot distances W₁ and W₂ in the radius direction on the optical disc 100a and optical disc 100b can be set to ½ of the guide groove pitch respectively and therefore,

W₁=S₁·sin θ=T₁/2

W₂=S₂·sin θ=T₂/2 and

S₂/S₁=T₂/T₁

When S₁, S₂ are each deviated from ½ of the guide groove pitch, since the DPP signal amplitude reduces according to the amount of deviation, the tolerance of the amount of deviation needs to be considered from the standpoint of the amount of decrease of the DPP signal amplitude.

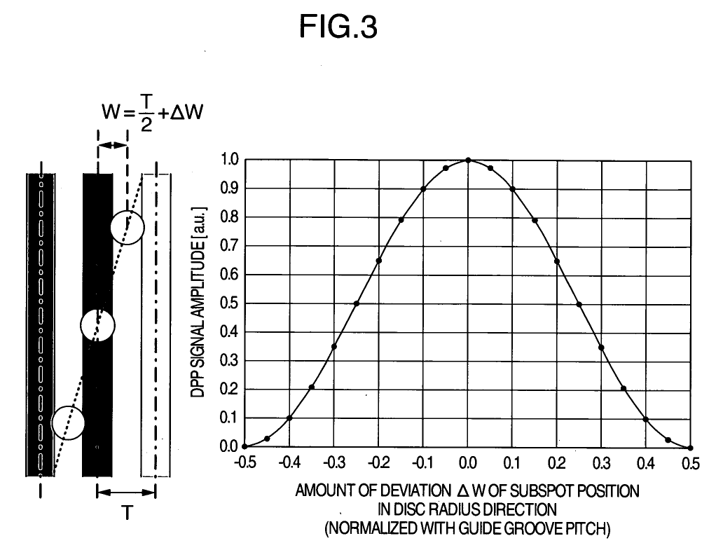

FIG. 3 is a schematic view showing a relationship between the DPP signal amplitude and the amount of subspot position deviation ΔW on the disc. As is appreciated from the graph, the DPP signal amplitude reaches a maximum when the spot distance in the radius direction is ½ of the guide groove pitch and the signal amplitude decreases according to the amount of deviation ΔW. From the standpoint of servo control, a decrease of the DPP signal amplitude on the order of 10% is sufficiently controllable, and therefore judging from FIG. 3, if the tolerance of the amount of deviation ΔW is 0.1 times the guide groove pitch,

W₁=S₁·sin θ=T₁/2±0.1·T₁=(0.5±0.1)·T₁W₂=S₂·sin θ=T₂/2±0.1·T₂=(0.5±0.1)·T₂

### Therefore, considering the above described contents, the range satisfied by S₂/S₁ is expressed by Formula 1.

$$\frac{{S}_{2}}{{S}_{1}} = k \cdot \frac{{T}_{2}}{{T}_{1}} \qquad [ Formula 1 ]$$

where 0.7<k<1.5

Here, the relationship between the spot distances S₁ and S₂ is generally determined by the relationship of lateral magnification of optical system between the BD optical system and HD DVD optical system, and therefore, it is eventually only necessary to set the lateral magnification of the respective optical systems to a desired relationship.

Since the definition of lateral magnification of an optical system is already generally known, detailed explanations thereof will be omitted. Assuming, for example, that the spot distance of three beams on an optical disc is S and the spot distance of three beams when the spots of the three beams on the optical disc are projected onto light-emitting points of a semiconductor laser is H, the definition of lateral magnification M of the condensing optical system is defined by Formula 3 below.

$$M = \frac{H}{S} \qquad [ Formula 3 ]$$

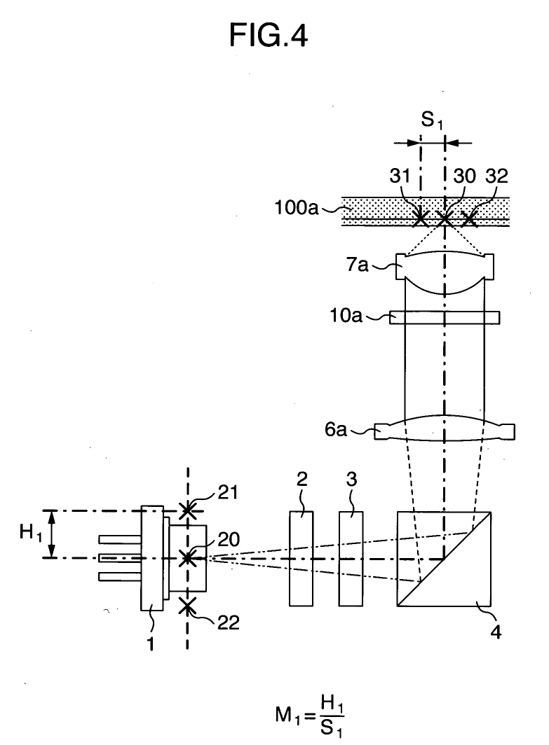

That is, the lateral magnification M₁ of the condensing optical system is defined as M₁=H₁/S₁ using S₁ and H₁ as shown in FIG. 4. Though not shown in the figure, the lateral magnification M₂ of the condensing optical system can also be calculated in the similar manner.

In this embodiment, since the BD optical system and the HD DVD optical system share the semiconductor laser 1 and diffraction grating 2, when the spots of three beams are projected onto the light-emitting points of the semiconductor laser, the spot distance between the three beams is the same for both optical discs. Therefore, the relationship between the spot distances S₁ and S₂ is as expressed by Formula 4 using the lateral magnification M₁, M₂.

$$\frac{{S}_{2}}{{S}_{1}} = \frac{\frac{1}{{M}_{2}}}{\frac{1}{{M}_{1}}} = \frac{{M}_{1}}{{M}_{2}} \qquad [ Formula 4 ]$$

That is, the relationship of Formula 2 can be derived from Formula 1 and Formula 4.

$$\frac{{M}_{1}}{{M}_{2}} = k \cdot \frac{{T}_{2}}{{T}_{1}} \qquad [ Formula 2 ]$$

where 0.7<k 1.5

This embodiment has a feature that the lateral magnifications M₁, M₂ of the BD optical system and HD DVD optical system have the relation of Formula 2.

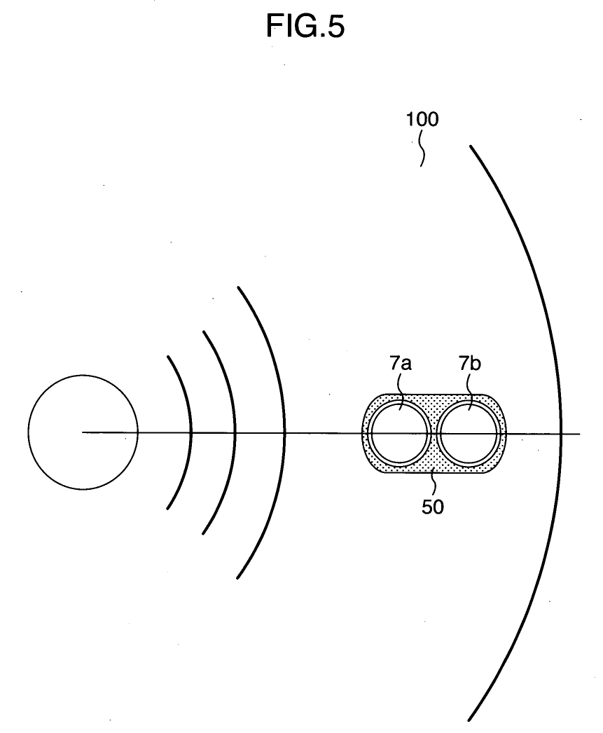

Here, as shown in FIG. 5, this embodiment has a feature that, for example, the objective lens 7a and objective lens 7b are held by the same lens holder 50. Furthermore, another feature is that the objective lens 7a and objective lens 7b are placed side by side in the radius direction with respect to the optical disc 100 which performs reproduction and recording. Arranging the objective lenses in this way makes it possible to always keep the tangential direction of the optical disc at every radial position in the same direction.

### Embodiment 2

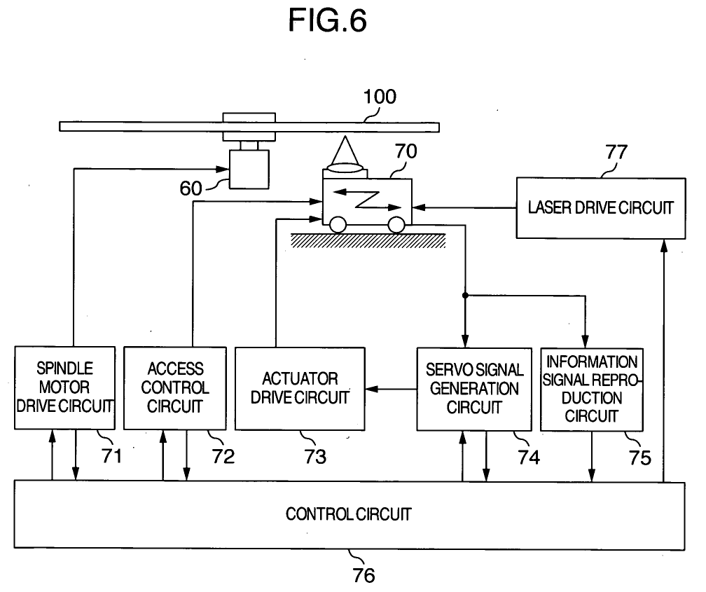

An embodiment related to the optical disc apparatus on which the optical pickup apparatus of the present invention is mounted is shown in FIG. 6. Reference numeral 70 denotes an optical pickup which has a configuration as shown in FIG. 1, for example. The optical pickup 70 is provided with a mechanism capable of sliding its position in the radius direction of an optical disc 100 and performs position control according to an access control signal from an access control circuit 72.

A predetermined laser drive current is supplied to the semiconductor laser in the optical pickup apparatus 70 from a laser drive circuit 77 and a predetermined amount of laser light is outputted according to reproduction or recording. The laser drive circuit 77 may also be incorporated in the optical pickup 70.

A signal detected from the photodetector in the optical pickup 70 is sent to a servo signal generation circuit 74 and information signal reproduction circuit 75. The servo signal generation circuit 74 generates a focus error signal and a tracking error signal from these detection signals, drives an actuator in the optical pickup 70 through an actuator drive circuit 73 based on these signals and thereby performs position control of the objective lens.

Furthermore, an information signal reproduction circuit 75 reproduces an information signal recorded in the optical disc 100 from the detection signal. Part of the signals obtained at the servo signal generation circuit 74 and information signal reproduction circuit 75 are sent to a control circuit 76. This control circuit 76 is connected to the laser drive circuit 77, access control circuit 72, actuator drive circuit 73 and spindle motor drive circuit 71 et cetra, which perform control of the amount of semiconductor laser light emission in the optical pickup 70, control of the access direction and position, rotation control of a spindle motor 60 which rotates the optical disc 100 et cetra, respectively.

While we have shown and described several embodiments in accordance with our invention, it should be understood that disclosed embodiments are susceptible of changes and modifications without departing from the scope of the invention. Therefor, we do not intend to be bound by the details shown and described herein but intend to cover all such changes and modifications a fall within the ambit of the appended claims.

1. An optical pickup comprising:
a semiconductor laser;
a first objective lens which condenses laser beam onto a first optical disc having a cover layer thickness of 0.1 mm;
a second objective lens which condenses the laser beam onto a second optical disc having a cover layer thickness of 0.6 mm;
a diffraction grating which causes the light beam outputted from the semiconductor laser to be diffracted into at least three light beams;
a beam splitter which branches the light beam to a first light beam directed to the first objective lens and a second light beam directed to the second objective lens; and
a photodetector which receives the first light beam reflected by the first optical disc and the second light beam reflected by the second optical disc,
wherein assuming that a spot distance of 0th-order light and first-order light on the first optical disc when the three light beams generated by the diffraction grating are condensed onto the first optical disc is S₁, a spot distance of 0th-order light and first-order light on the second optical disc when condensed onto the second optical disc is S₂, a guide groove pitch of the first optical disc is T₁ and a guide groove pitch of the second optical disc is T₂,
$$\frac{{S}_{2}}{{S}_{1}} = k \cdot \frac{{T}_{2}}{{T}_{1}} \qquad [ Formula 1 ]$$
where 0.7<k<1.5 is satisfied.

2. An optical pickup comprising:
a semiconductor laser;
a first objective lens which condenses laser beam onto a first optical disc having a cover layer thickness of 0.1 mm;
a second objective lens which condenses the laser beam onto a second optical disc having a cover layer thickness of 0.6 mm;
a diffraction grating which causes the light beam outputted from the semiconductor laser to be diffracted into at least three light beams;
a beam splitter which branches the light beam to a first light beam directed to the first objective lens and a second light beam directed to the second objective lens; and
a photodetector which receives the first light beam reflected by the first optical disc and the second light beam reflected by the second optical disc,
wherein assuming a lateral magnification of optical system which is consisted of the condensing optical system on the semiconductor laser side and the condensing optical system on the optical disc side made up of the first objective lens is M₁, lateral magnification of optical system which is consisted of the condensing optical system on the semiconductor laser side and the condensing optical system on the optical disc side made up of the second objective lens is M₂, a guide groove pitch of the first optical disc is T₁ and a guide groove pitch of the second optical disc is T₂,
$$\frac{{M}_{1}}{{M}_{2}} = k \cdot \frac{{T}_{2}}{{T}_{1}} \qquad [ Formula 2 ]$$
where 0.7<k 1.5 is satisfied.

3. The optical pickup according to claim 1, wherein the beam splitter is a PBS prism.

4. The optical pickup according to claim 2, wherein the beam splitter is a PBS prism.

5. The optical pickup according to claim 1, wherein a differential push-pull method is used for tracking error signal detection on the first optical disc or the second optical disc.

6. The optical pickup according to claim 2, wherein a differential push-pull method is used for tracking error signal detection on the first optical disc or the second optical disc.

7. The optical pickup according to claim 1, wherein the first objective lens and the second objective lens are held by an identical lens holder.

8. The optical pickup according to claim 2, wherein the first objective lens and the second objective lens are held by an identical lens holder.

9. The optical pickup according to claim 7, wherein the first objective lens and the second objective lens are placed side by side in a radius direction of the optical disc.

10. The optical pickup according to claim 8, wherein the first objective lens and the second objective lens are placed side by side in a radius direction of the optical disc.

11. An optical disc apparatus comprising:
the optical pickup according to claim 1;
a laser drive circuit which drives the semiconductor laser in the optical pickup;
a servo signal generation circuit which generates a focus error signal and a tracking error signal using a signal detected from the photodetector in the optical pickup; and
an information signal reproduction circuit which reproduces an information signal recorded in the optical disc.

12. An optical disc apparatus comprising:
the optical pickup according to claim 2;
a laser drive circuit which drives the semiconductor laser in the optical pickup;
a servo signal generation circuit which generates a focus error signal and a tracking error signal using a signal detected from the photodetector in the optical pickup; and
an information signal reproduction circuit which reproduces an information signal recorded in the optical disc.
